(19) United States
(12) Patent Application Publication
(10) Pub. No.: US 2008/0162339 A1
(43) Pub. Date: Jul. 3, 2008

(54) System and method for creating, funding and using a dedicated bank account for a specific subsequent transaction

(76) Inventor: Tabbatha Christie Lawe, Chapel Hill, NC (US)

Correspondence Address: TABBATHA LAWE, 101 LONGWOOD DR., Chapel Hill, NC, 27514, US

(21) Appl. No.: 12/002,966

(22) Filed: Dec. 19, 2007

Related U.S. Application Data
(60) Provisional application No. 60/877,328, filed on Dec. 27, 2006.

(51) Int. Cl. G06Q 40/00

(52) U.S. Cl. 705/39; 705/35

(57) ABSTRACT

The invention provides a system and method for the creation of a special purpose gift bond account for the purchase of specific subsequent transaction. A card and card carrier are created and a donor purchases the card and card carrier to give to a recipient who completes online HTML forms to create the recipient's own special gift bond account at a participating bank with the account funded from cash paid for the purchase of the card and card carrier. The funded gift bond bank account is then only used to purchase item(s) for a specific subsequent transaction such as for a US Savings Bond from the US Treasury.

This application claims benefit of my provisional application 60/877,328 filed Dec. 27, 2006.

### BACKGROUND OF THE INVENTION

1. Field of the Invention

This invention relates generally to systems and methods for using a stored value gift card to create and fund a special purpose bond bank account for use in a specific subsequent transaction such as to purchase a US Savings Bond.

2. Background of the Invention

Since at least 2002, US savings bond EE sales have been declining by an average of 14% a month using a month-to-prior-year-month comparison. The long-term impact of fewer US savings bond sales has not been adequately measured, but as the population of The United States grows, it is clear that the percent of individual US citizens who support their government through the purchase of US savings bond is dropping at a time when government borrowing is at an all time high. Extensive historical efforts by the US Treasury to promote the purchase of US savings bonds have highlighted the patriotic value realized by citizens who make such purchases. The recent drop of US savings bond sales and the lack of US savings bonds given as gifts are eroding the sense of patriotism associated with US savings bond purchases. Moreover, because fewer US citizens are purchasing savings bonds for themselves or as gifts for others, the US Treasury and the US economy are becoming more and more dependent on foreign countries such as China and Japan to fund US government debt. An Oct. 25, 2005 article in the online magazine “Atlantic Online” states: “China, is the United States' second-largest lender, after Japan. China's investment in U.S. government debt has more than tripled in the past five years, from $71 billion in 2000 to $242 billion in 2005.”

There are several existing bond-purchase-method factors which contribute to the precipitous decline in the purchase of US savings bonds by US citizens. The physical issuance of US savings bonds follows an existing regulated, complex and time consuming method. Moreover, the compensation provided by the US Treasury department to US savings bond issuing agents does not generally cover the full cost to issue the bond. Thus, under the current method, issuing US savings bonds is a money losing proposition for most issuing agents and this creates a disincentive to proactively promote and sell US savings bonds especially as gifts. Nearly all issuing agents are banks, and the fee paid by the US Treasury Department for issuing a US savings bond ranges from $0.50 to $0.85 per bond contract processed. This fee generally does not cover the cost of a bank teller's time to provide the forms, then review the form and otherwise complete the process for the US savings bond contract. In most cases, if a bank where to properly account for the full cost of processing and managing the US savings bond transaction it would show a loss for issuing US savings bonds. This current level of US Treasury compensation inhibits the active promotion of US savings bonds by bank issuing agents. The net-effect of this low compensation is that banks no longer actively promote or market US savings bonds to customers. They provide the service as a value-added benefit at a loss to customers of the bank when asked, but do not generally proactively promote US savings bonds. This lack of marketing and promotion by the primary US savings bond issuing agents/banks has led to the serious decline in US savings bonds. Since banks are the primary distribution arm and since they are not promoting the bonds, it is logical to conclude a continuing drop in bond sales.

Secondly, customer visits to banks have fallen precipitously. According to Synergistics Research, consumer visits to bank branches dropped 37% from 1995 to 2002. There is a well-known bromide in retail that says the three most important elements of retail success are: location, location and location. Because fewer people are going to banks, banks are clearly the wrong location to sell US savings bonds. The lack of bank branch visits translates into fewer opportunities for a bank to promote or issue US savings bonds. Fewer bank visits clearly means fewer US savings bond sales.

Third, a large portion (estimated to be 35%) of US savings bonds are issued as gifts and the current method to sell US savings bonds as a gift is onerous for the donor and decidedly disadvantageous for the donor compared to buying and giving other gifts of similar value. In most cases, the US savings bond gift donor must physically visit a bank, acquire and complete the paperwork for the gifted US savings bond and submit the completed paperwork back to the bank teller with funds for the bond contract. This method of buying a US savings bond as a gift adds significant cost to the donor in terms of time and energy over and above the value of the US savings bond. It is also important to note that after making the purchase, the donor may or may not receive a paper gift-certificate from the bank teller to present to the recipient. The lack of a physical form factor, which acts as substitutes for the US savings bond, is a further barrier for gift giving. Donors who purchase a gift US savings bond and have no physical form factor to present to the recipient for the gift, are left to their own devices in describing the gift of the US savings bond to the recipient. This is a cumbersome barrier and one which dissuades donors from purchasing the US savings bond as a gift using the current method. To make matters worse, in most cases, the donor often makes a second trip to a traditional retail outlet to purchase a card to carry the message of the bond gift, such as a birthday card, graduation card or congratulation for the new-baby card, in which the donor notes the US savings bond gift. This extra trip adds further time and effort “costs” to the transaction under the current method.

Fourth, the sale of US savings bonds as gifts is further hampered by the requirement that each US savings bond must have a valid Social Security number associated with it. Donors will often fail to buy a US savings bond as a gift because they do not know the gift recipient's social security number. Many donors do not know that they can use their own social security number when buying the gift, but even if they do understand it within the current method, the donor will often recognize the use of the donor's social security number creates yet another level of complexity and cost for the recipient who may alternatively assign their own social security number to the received US savings bond. Donors are also concerned that the use of the donor's social security number may inadvertently lead to the gift recipient seeing the donor's social security number, thereby compromising the donor's privacy and opening the donor to identity theft. These added hassles and impediments in the current method are hidden costs in giving a US savings bond as a gift and the current method of US savings bond gift-giving creates a significant barrier for the donor thereby leading to a reduction in the sales of US savings bonds.

Fifth, the donor of a US savings bond must provide the recipient's address so the Treasury or appropriate Federal Reserve Bank can send the recipient the physical form for the US savings bond. This requires that the donor have the recipient's address at the point of bond contract payment. If the donor does not have the recipient's address, the donor is allowed to use their own address, but once the actual US savings bond certificate arrives, the donor is beholden to deliver the certificate to the recipient. Once again, this added hassle within the current method of US savings bond gift purchasing is a hidden cost and creates a significant barrier and disincentive for the donor.

Sixth, the lack of new retail outlets has hampered the sale of US savings bond. Since 1995, banks have reduced full-service branch bank locations dramatically. Moreover, the traditional location for purchasing items, and particularly gift items, is in retail locations. Heretofore, retailers did not have the proper systems nor did they have the required manpower nor were they licensed to effectively accept and process contract forms for issuing US savings bond to buyers. Retailers do not want to sell US savings bond under the current issuing agent model because of costs and complexity associated with the issuing transaction and regulations for issuing US savings bonds.

Seventh, in addition to the inhibitors identified for the donor, the process for a gift recipient to accept the value of the US savings bond as a gift is also overly complex. When a gift of a US savings bond is given, at best the gift recipient often only gets a simple gift certificate. The gift certificate generally relays limited information; usually only that a US savings bond of a certain amount is pending. The gift recipient is not informed of other aspects of the US savings bond. The recipient is not advised on information sources for the US savings bond. Further, in many cases the recipient will be required to update the recipient's social security number or address to allow for the proper assignment of the US savings bond.

Eighth, the US Treasury department has recognized the ubiquity and cost advantages of sale transactions of US savings bonds on the internet and has made purchasing US savings bonds relatively easy and simple on the web. However, while the Treasury has made the transaction easier to execute on the web, the Treasury has not appropriately stepped up marketing efforts to inform buyers that US savings bond sale transactions can be completed on the web. At the same time, the Treasury does not have the funds to promote US savings bonds, the traditional issuing agent cannot afford to promote the US savings bond option either because of the cost issues mentioned earlier. This lack of marketing to US citizens by either the Treasury or the traditional issuing agent has also resulted in fewer and fewer Series EE bond sales. Many donors are older US citizens purchasing US savings bonds for grand-children or younger nieces and nephews. Many older citizens have not adopted web-based purchasing in the same percentage and with the same comfort level as a younger gift recipient's generation. The current method allows for severely restricted promotion of US savings bond sales. Moreover, the process to purchase a US Savings Bond directly from the Treasury on the web is hampered by the US Treasury's regulatory restriction that any bond buyer must have a valid bank account. This narrows the purchasing behavior only to US citizens that either already have a valid bank account and/or are willing to give Treasury their bank account information. This is a restrictive process which reduces sales to many US citizens.

Ninth, the current method which requires the combination of the donor purchasing and entering required data for the US savings bond, the delays incumbent in receiving the actual US savings bond certificate and the frequent requirement for subsequent recipient information updates leads to frequent instances where the owner of the bond is not clearly identified by the proper Social Security number, name and address of the recipient. As such, the bonds are often not properly accounted for by the donor, the gift recipient or the Treasury. In time, the bonds become forgotten and eventually are considered lost property. The Treasury Department has a unit that works to find bond owners. Both gift donors as well as recipients see this potential of forgotten bonds as a detriment to the current method. Rather than taking the risk of losing the US savings bond value over time, many donors simply choose a different gift for the recipient.

Tenth, the agency relationship and sale of US Savings Bonds is heavily regulated by the US Treasury Department. The US Treasury Department has currently restricted the agency role for US Savings Bonds to bank's acting as agents for the Treasury as well as through TreasuryDirect.gov. Further Treasury has expressed serious reservations for any sale of a product expressly concurrent with the sale of a US Savings Bond. For instance, in some instances consumers were given a US Savings Bond concurrent with a purchase of a set of tires, or even boxes of cereal. Treasury has moved to restrict this method of sale and has made clear via their role as a regulating entity that a direct sale of a bond using a bank agent or using TreasuryDirect.gov is the preferred and acceptable sale process. Directly tying bond sales to the sale of other products is frowned upon and is not permitted. Nevertheless, Treasury has always allowed financial institutional to sell the financial institutions own financial products or establish accounts where a consumer can “buy” shares or deposit funds, which funds are then used to buy Treasury Bonds.

### OBJECTS AND ADVANTAGES

Accordingly, several objects and advantages of my invention are providing a system and method to allow a gift donor to buy and give a unique card and card carrier product to a gift recipient who can then use the card and card carrier to create a special purpose bank account which can be used solely to purchase a specific item, such as a US Savings Bond directly from the US Treasury. The special purpose bank account, known as a gift bond account, is funded by a donor who has purchased the card and card carrier at a retail establishment or was given a card and subsequently activates it and gives the activated card to a recipient. Once the account is created by the recipient of the card, the special purpose gift bond bank account can only be used to fund the purchase of a specific item, such as a US Savings bond, purchased directly through a transaction initiated by the participating bank. The system provides the donor with the ability to efficiently fulfill her intention of funding the purchase of a specific item, such as a US savings bond, as a gift through one simple donor transaction which requires no additional data entry by the donor or exposure of donor's private information. Moreover, because the US Savings Bond is only associated with, but is not physically the item purchased concurrent with the card, the card representing the gift bond bank account and the bond purchase contract are distinct and thus the gift bond bank account card can be sold in any number of retail locations without violating Treasury regulations. In the preferred embodiment, the ability to purchase the card and card carrier—which are to be used to fund the bond account and subsequent bond purchase—at retail locations will increase the likelihood of more US savings bond sales. More US savings bond sales will increase the sense of patriotism in the population while making the gift process simpler for the donor. When purchased at a retail location and given to the recipient, the card and card carrier provides the recipient with all necessary instructions so the gift recipient can create a gift bond account at a participating bank which will then complete the contract for the purchase of a US Savings Bond, all via internet connections. When the recipient chooses to create their own gift bond account at the bank, at a minimum he/she inputs enough information to validate the card is active and to then create the gift bond account and subsequently purchase the US Savings Bond. Such information includes, name, age, social security number and email address along with a card number and unique PIN number found on the received card and card carrier. This information is entered into internet based web forms at a gift web site and at a participating bank site. Upon receipt of the valid information, the system creates the gift bond account. The creation also triggers the funding of the account by authorizing the participating bank to transfer the cash associated with the account from a reserved financial account into the newly created recipient bank account. Once the gift bond account is created and funded, the system can notify the account holder via email of the account numbers and instructs the account holder to use the account numbers to purchase item from the pre-defined vendor, such as a US Savings Bond from the TreasuryDirect.gov website. Alternatively, in the preferred embodiment of the invention, the bond purchase contract is automatically instigated by the bank on behalf of the gift bond bank account holder. Upon completion of the purchase or bond contract, the pre-defined vendor makes an automated clearing house (ACH) request or other funding request to access funds from the established special purpose bank account at the participating bank. Upon receipt of the proper funds request only from the pre-defined vendor, the bank releases the funds and the subsequent purchase is consummated.

The invention system and method is designed to utilize the gift recipient as the data-entry person for the ultimate purchase of the item, such as a US Savings Bond, rather than the retailer, bank agent or the donor. The use of the gift recipient for the required data entry provides for more accurate and immediate capture of relevant information without the retailer, bank agent or the donor spending time to enter or verify data. The use of the gift-recipient also avoids the cost of any other party entering the data. The gift system eliminates many of the inhibitors that a donor faces when considering gift options. In the preferred embodiment, the account system provides one retail transaction to fulfill the donor's intention for the ultimate purchase of a US savings bond as a gift. The donor also does not need to provide the donor's social security number in the proposed system and method. The donor also does not have to provide her own address nor will the donor have to find and enter the recipient's address or social security number. The elimination of these inhibitors will increase the attractiveness of the US savings bond as a gift and increase sales, as well as increase the donor and recipient's sense of patriotism. Moreover, the gift system's use of web-based forms to create, fund and use the account for the purchase of a US savings bond, ensures the forms can be filled out more correctly. The creation of a dedicated special purpose gift bond bank account through capture of information over web-based forms is also a highly efficient method for bank account creation. In addition to allowing a bank to more broadly and easily acquire a new customer, the system and method provide for more accurate input of recipient information thereby helping to ensure proper gift bond account creation and subsequent tracking of the US savings bond. By helping the US Treasury establish a direct relationship with the bond holder, fewer US savings bond sales will be forgotten. Furthermore, because the system is based on the initial purchase of a card and card carrier which provides value above and beyond the cash reserved for the gift bond account or only for the purchase of the US savings bond, (such value coming in the form of the card and card carrier and the convenience of the retail distribution and simplicity of the method), the card and card carrier and service can be sold for an amount above the cost of the US savings bond alone. The additional value associated with the purchase of the card and card carrier will include a built in value for the convenience delivered to the donor. A portion of this additional value captured at purchase can be subsequently used by the retailer and the gift-system operator to increase distribution and actively promote US savings bond sales to consumers which will, in turn, increase a sense of patriotism in more US citizens.

The proposed method also satisfies the Treasury guidance on clearly delineating a bond sale from the concurrent sale of any other item. In this case, the card and carrier purchased by the donor provide a clearly different product offering the creation of a bank account rather than promoting the direct sale of a US Savings Bond. The product offering associated with the card and card carrier is for a bond bank account. The donor is purchasing the card and card carrier to provide funds for a recipient to open a special purpose bond bank account. By subsequently establishing the bond bank account the recipient causes the cash from the donor to be deposited in the bond bank account in the recipient's name and the recipient's establishment of the special purpose account also authorizes the participating bank to initiate the savings bond contract for the recipient with Treasury. In this way, the system and method provide a product offering similar to existing mutual funds and/or money market accounts where a consumer's funds are deposited with a financial institution and then subsequently used to purchase Treasury bonds. The donor does not purchase the bond. Nor can the card be used by itself to purchase the bond. The card can only be used to open a bank account. Once established, the bank account and the bank can initiate the subsequent Savings Bond purchase. This provides for compliance with Treasury's regulations, practices and guidance.

### SUMMARY OF THE INVENTION

The preferred embodiments of the present invention provides a system and method for a donor to acquire a card and card carrier to be given to a recipient who can use cash reserved with the activation of the card, to create a special purpose bond bank account at a bank in the recipient's name through the recipient's completion of HTML forms including the entering of the recipient's social security number, name, and other identifying information after the card number and PIN number from the card is validated. The entered account information is then used to create a gift bond bank account record in the recipient's name at the bank and the record is updated on the bank's database to activate the gift bond bank account for the recipient. The bank account is notated to ensure a withdrawal can be made only for the purchase of a specific subsequent transaction from a pre-defined vendor. The cash reserved at the time of the purchase of the card is moved from a special reserve account into the newly created special purpose bank account in the recipient's name. An email is sent to the account holder either informing the account holder how to subsequently purchase the specific item, such as a US Savings Bond, using cash from the account or confirming the account holder's contract for the purchase of a specific item, such as a US Savings Bond, has been automatically placed by the bank with the vendor, such as the US Treasury after the account was created. When the item is purchased by the recipient from the pre-defined vendor, the vendor, such as the US Treasury, can be provided the funds and bond-holder information by the bank or, the vendor can request the funds for the purchase by optionally sending an automated clearing house (ACH) request for the appropriate funds to be withdrawn from the created gift bond account or provided by the bank, the bank receives the request and validates the ACH request is from the pre-defined vendor and fulfills the ACH transfer transaction to complete the item purchase.

A database of unique card number records is created by randomly generating unique alpha-numeric card number characters in individual card records within a card database. Additionally, a denomination value is assigned to each unique card record in the database. In one embodiment of the invention, the denomination value assigned to the card number record is cash equivalent to $25.00. Thus, a record is created with a unique card number, such as “Yf395PxKadS21T9t44” and is associated with a specific denomination, such as $25.00. In the preferred embodiment, a PIN code number is also associated with the card record. The PIN code is a different card number such as “8493085209.”

Next, each card number and PIN is associated with a specific card and card carrier. Association can be made by directly printing the card number and PIN on the card itself or by printing the card number on any item and attaching said item with the printed card number to the card carrier to create a card and card carrier or by embedding the card number and/or pin on magnetic material on the card, by using a bar-code or other association method on the card. Once a number is associated with a card, the database record locks the unique alpha-numeric card number and PIN code number strings from being used on any other card and card carrier. Once a card and card carrier have the unique alpha-numeric card number and PIN assigned to it, the card and card carrier is made available for sale or customer acquisition at a retail location. In the preferred embodiment, the card and card carrier have a patriotic theme which further re-enforces the patriotic values a donor and recipient will receive when using the product to purchase a US savings bond gift card.

The card and card carrier and assigned number and PIN provide information needed for the subsequent creation of a special purpose gift bond account at a bank. Both the donor and the recipient are informed of the required method to create the gift bond account at a bank, through text instructions printed on the card and card carrier. The donor can read this prior to purchasing the card and card carrier and the recipient can read the text after receiving the card and card carrier.

The card and card carrier will be made available to donors at any type of retail location accessible by the donor or may be otherwise given to the donor. The donor selects a card and card carrier at the retail location. The donor then takes the selected card and card carrier to the retail location check-out location and pays for the card to activate it or takes the card home free for later activation using the donor's computer or touch-tone telephone and a credit card. In another embodiment, when the card is given to the donor, the donor can activate the card by paying for it using a credit card and input device such as a telephone or web-browser.

After activation, that portion of the purchase price paid to activate the card expected to be used for the subsequent purchase of an item, such as a US Savings Bond, from a bank account associated with card and card carrier is deposited in a reserved financial account at the participating bank.

The system next awaits the recipient's redemption of the activated card through the system's internet account validation web site. The card and card carrier includes text instructions to the donor and recipient which explains how the reserved-value is to be used to create the recipient's gift bond account at a bank. The instructions optimally explain how the recipient may use any computer with web-browser to go to a specified web-address such as www.USgiftBonds.com. Once at the website, the gift recipient is prompted to enter the card number and PIN code number which is assigned to the activated card and card carrier. In the preferred embodiment, the PIN code unique alpha-numeric card number character string is printed in human-readable form under a scratch-off film associated with the card and card carrier. The scratch-off film prevents a casual observer of the card from seeing the PIN code number until executing the online redemption. This provides an additional measure of security for the gift system.

Returning to the method, once at the system's web-site the gift recipient is instructed to scratch-off the protective film and type the card number and revealed PIN code number into web-fields. The recipient next clicks a “Begin” button.

Once the recipient enters the alpha-numeric card number and PIN code number and other requested information, the system sends a query message to the card database seeking confirmation that the entered card's alpha-numeric card number was properly activated. If the card database returns a message that says the card number is not activated, the web-site system returns a message screen via the recipient's browser stating that the card number is not activated and the donor is asked to begin the process again.

If the card database returns a message saying the card number is activated, the system returns a message screen via the recipient's browser informing the recipient that the information was received, the card is active and the recipient continues with the process.

Next, the web-site system passes the recipient through the internet to the bank's web site. In passing the recipient through the internet to the bank's web site, the system provides the bank's web site with the recipient's entered valid card number and PIN number and other relevant data such as the recipient's entered email address. These are passed to the participating bank's web site along with an appropriate notation for the cash denomination amount associated with the recipient's record such as “$25.00”. Thus, when the bank's web site receives the recipient on its web site it also receives data relevant to the recipient indicating the bank should precede with the recipient's gift bond account creation step. In another embodiment, the system can return another input screen to the recipient asking for the recipient's personally identifying information from the system. Alternatively, the system can pass the recipient directly to the TreasuryDirect.gov site for the donor to enter their personally identifying information.

In the gift bond bank account creation step, the bank's web site (or the web-site system) includes input screens for the recipient's social security number along with appropriate information about the recipient including the recipient's full name, email address, physical address and phone number or other information required to open the bank account and subsequently make the purchase of an item like a US Savings Bond.

Next, the bank web-site confirms receipt of the recipient's data and assigns an account number and establishes the recipient's gift bond account at the bank. Alternatively, the Account Verification system can maintain a database of available blank bank account numbers and can select and assign an available account number to the recipient's record prior to sending the full record to the participating bank.

Once the account is created, the bank initiates a funds transfer from the reserved financial account for the amount assigned to the recipient's newly created account, such as the $25.00 assigned to the card. Alternatively, at an appropriate time, the gift bond system can initiate a single transaction to provide the needed funds for any created account. At the conclusion of this process, the recipient's gift bond account is established and funded with the money reserved after the purchase of the card and card carrier.

Next, the bank initiates a routine on its system to execute a bond contract between the recipient and the US Treasury. The process of executing the bond contract is regulated by the United States Treasury and can be implemented differently by each participating bank system. However, the initiated bond contract will use information provided by the recipient during the gift bond bank account creation process and the cash need to fund the bond contract will be provided from the funds deposited in the recipient's created gift bond bank account.

Alternatively, rather than the bank creating the bond contract, the system can send an email to the recipient confirming the establishment of their gift bond account along with text instructions for the recipient explaining how to complete the specific purchase from the pre-defined vendor. In the preferred embodiment, the specific purchase is for a US Savings Bond. In the alternative method, the Savings Bond can be purchased by visiting a specific US Treasury website to complete online forms at the Treasury website. The email includes the recipient's bank account and routing number for the established gift bond account in the recipient's name which would be used by the recipient on the Treasury website to complete the bond purchase.

Another alternative is to use the initial web-site input forms after validation to capture information needed by the US Treasury's TreasuryDirect.gov site. The system could then provide the information to the US Treasury, who could then establish a TreasuryDirect.gov account in the recipient's name. In this way, the recipient only enters information once. Likewise, the system could simply validate the card and then pass the recipient directly to TreasuryDirect.gov for completion of the account forms only once and bond purchase at TreasuryDirect.gov. Funds for any purchase could then come from the master reserve account.

Once the bank completes the bond contract process to purchase the item from the pre-defined vendor, the pre-defined vendor, in the preferred embodiment the pre-defined vendor is the US Treasury, the bank can submit the bond contract and the cash for the bond contract to the US Treasury as is proscribed by Treasury Regulations. Alternatively, the US Treasury can send an automated clearing house (ACH) transaction request to the participating bank to withdraw the amount of money required to purchase of the intended item from the vendor and the bank fulfills the request.

At that point, the system has completed its process by formally submitting the bond contract to the Treasury. Subsequently the donor would receive a paper bond in the mail from the US Treasury or would have an electronic record of a bond held by TreasuryDirect.gov.

### BRIEF DESCRIPTION OF THE DRAWINGS

These and other features and advantages of the invention will now be described with reference to the drawings of certain preferred embodiments, which are intended to illustrate and not to limit the invention, and in which:

FIG. 1 is a high-level architectural drawing illustrating the primary components of a system for creating, funding and using a dedicated bank account for a specific subsequent transaction.

FIG. 2 is a block flow diagram illustrating the method in accordance with the invention.

FIG. 3a-e are sample cards and card carriers with a unique alpha-numeric card number and PIN Code number and printed instructions.

FIG. 4 is a block flow diagram illustrating the recipient's gift bond bank account verification and creation process.

FIG. 5 is a diagram of a card database record format associated with a gift card.

FIG. 6a-b are sample web page forms used for the verification and creation of a gift bond bank account.

FIG. 7 is a sample email of an alternative method for the recipient to make the subsequent purchase of a US Savings Bond using the created bank account.

### DETAILED DESCRIPTION OF THE PREFERRED EMBODIMENT

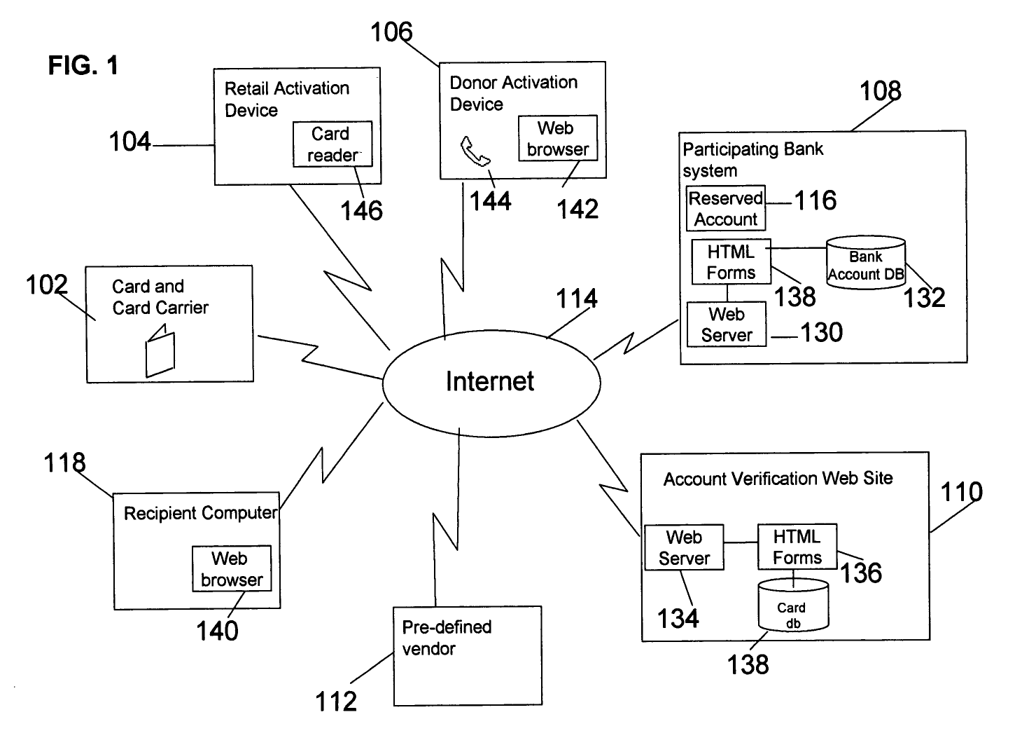

FIG. 1 is a high-level architectural drawing illustrating the primary components of a system and method for creating, funding and using a dedicated bank account for a specific subsequent transaction. In the preferred embodiment, the specific subsequent transaction made with funds from the created and funded gift bond bank account is a contract for a US Savings Bond. The gift bond account system includes a card and card carrier 102, a retail activation device 104, a donor activation device 106, an Account Verification web site 110, a participating bank account system 108, a pre-defined vendor 112, a recipient's computer 118, and the internet 114 for linking the systems together.

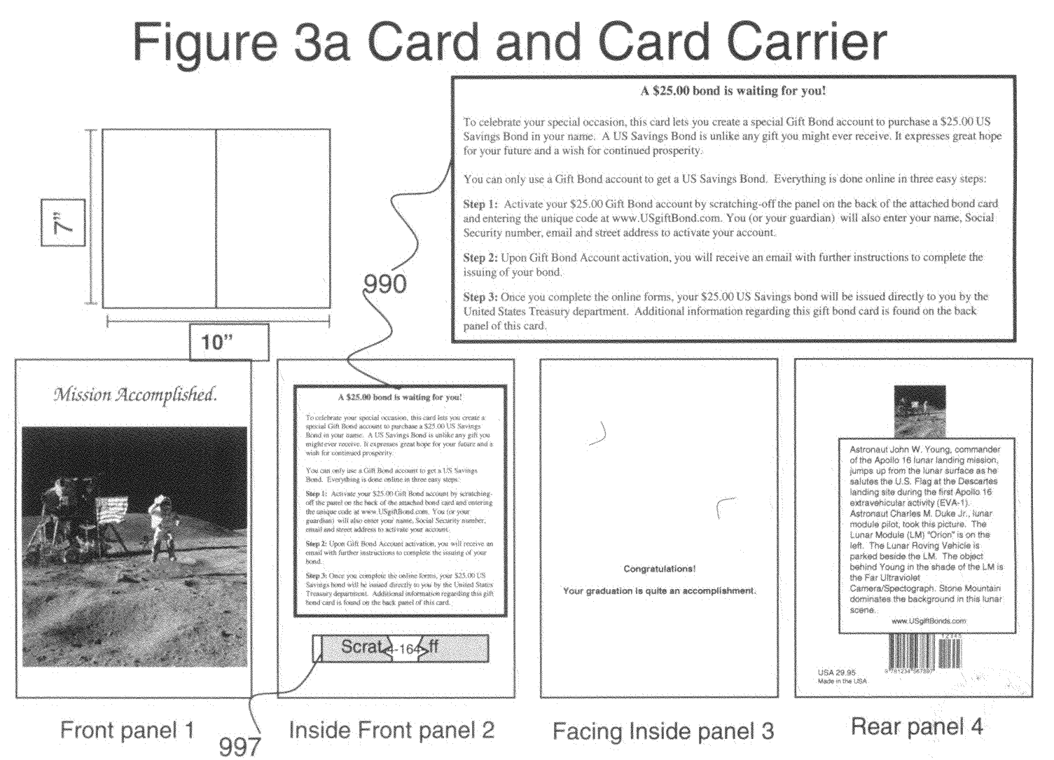

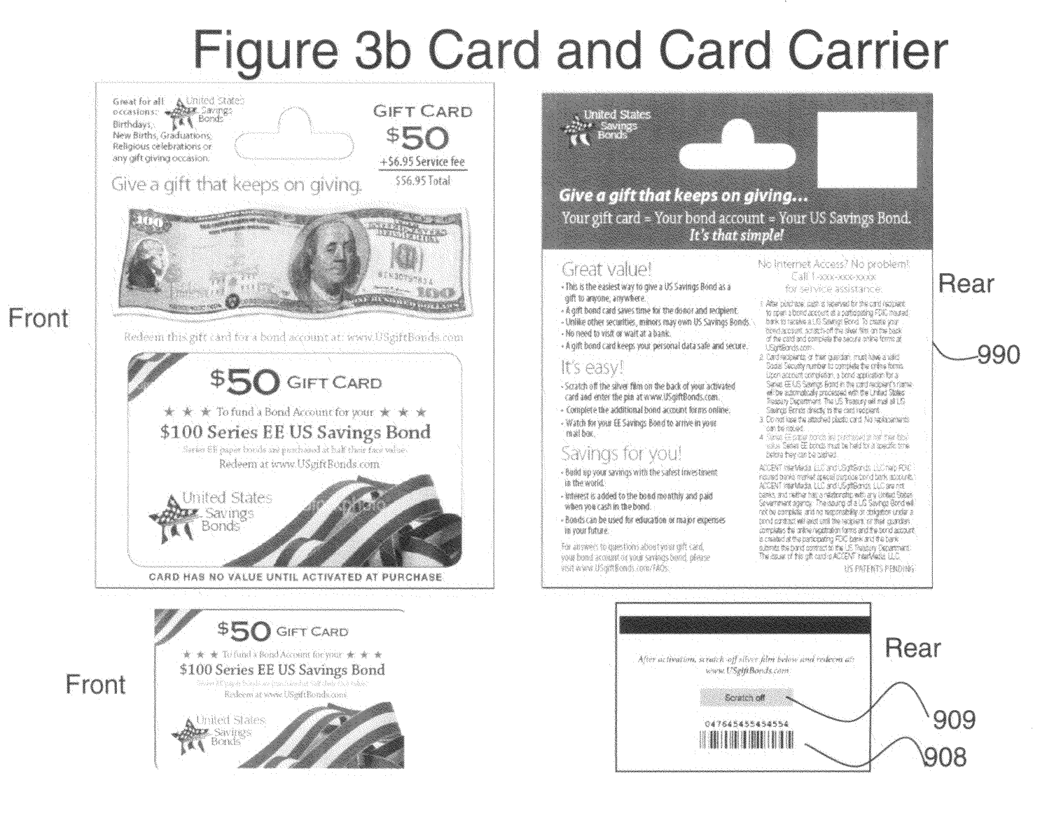

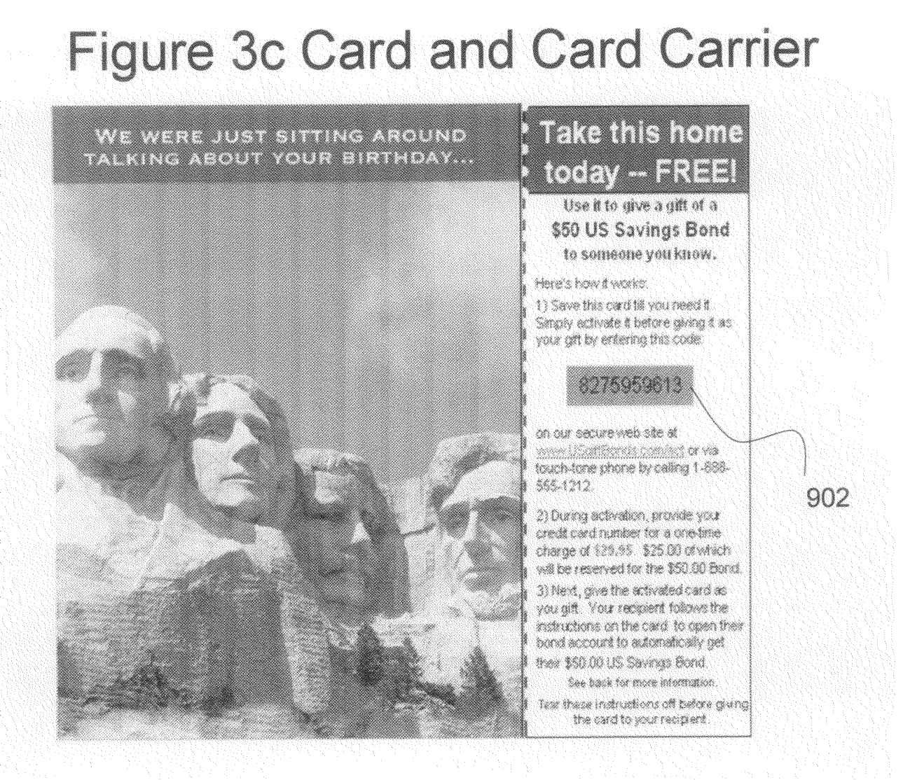

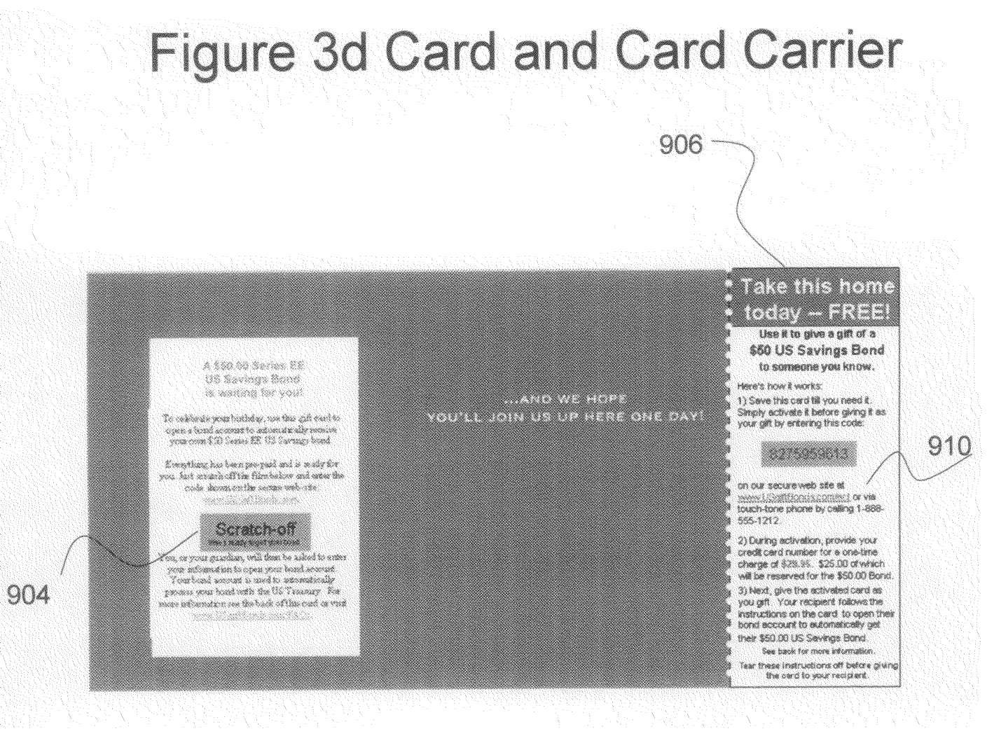

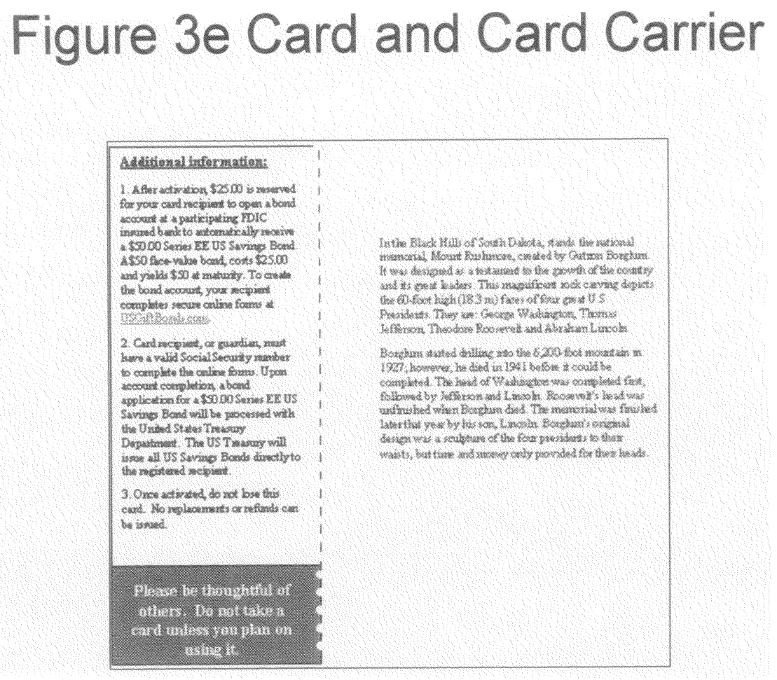

The card and card carrier 102 may be any type of printed card and card carrier such as a birthday, graduation, new birth, thank you or any special occasion printed card of any size. FIG. 3a-e are sample card and card carriers. The card and card carrier 102 includes a unique alphanumeric card number and a PIN code printed in readable form. In one embodiment, the card and card carrier 102 (FIG. 3b) can include an attached plastic card which may include the unique alphanumeric card number and PIN printed on the plastic card and attached to the card and card carrier 102. In another embodiment, the card and card carrier 102 (FIG. 3c-e) can include only a paper card printed with a unique alphanumeric card number (FIG. 3c, 902) and Pin (FIG. 3d, 904) on a single card with no plastic card. The card and card carrier 102 can be various sizes or shapes. In one embodiment the gift card 102 is only made of card stock folded to the standard five inch by seven inch card format with an extra two inch perforated extension showing instructions for the use of the card to create the gift bond account (FIG. 3d, 906). FIG. 3b represents another embodiment of the card and card carrier 102. In the preferred embodiment, the card and card carrier 102 is intended to have a patriotic theme to further achieve one goal of patriotism for the donor and recipient. The card and card carrier 102 also include standard printed instructions explaining the creation of the gift bond account and the process for funding the account as well as explaining restrictions on funds held in the account. In the preferred embodiment, the funds added to a created gift bond bank account can only subsequently be used to purchase a US Savings Bond. The instructions are an important element as they relay instructions to a gift donor prior to purchase and to a gift recipient after the purchase.

The Retail Activation Device 104 is a standard piece of equipment found at retail checkout stands which includes a card reader 146. The card reader 146 is capable of scanning a bar code or magnetic stripe on the back of the card and card carrier 102 (FIG. 3b). During purchase the donor brings the card to the retail checkout associate who collects the funds for the purchase of the card and activates the card using the card reader at the checkout stand.

The Donor Activation Device 106, can be any device used by the donor as an alternative method to activate the card outside of a retail environment. One such device can be a standard touch-tone telephone 144. Alternatively, the donor can use a PC equipped with a web browser 142.

The participating bank system 108 is a bank account system tied to a network, such as the internet 114, and accessible by the Account Verification web site 110. The participating bank system 108 consists of a web server 130 which accepts and process electronic messages from the Account Verification web site 110 and from the recipient's computer 118 via HTML forms 138. The participating bank system 108 also includes a bank account database 132 which contains unique bank account records for gift bond bank accounts. The participating bank system 108 also includes a reserved financial account 116 which is a depository account holding general funds to be used to fund individual recipient's gift bond accounts after account creation.

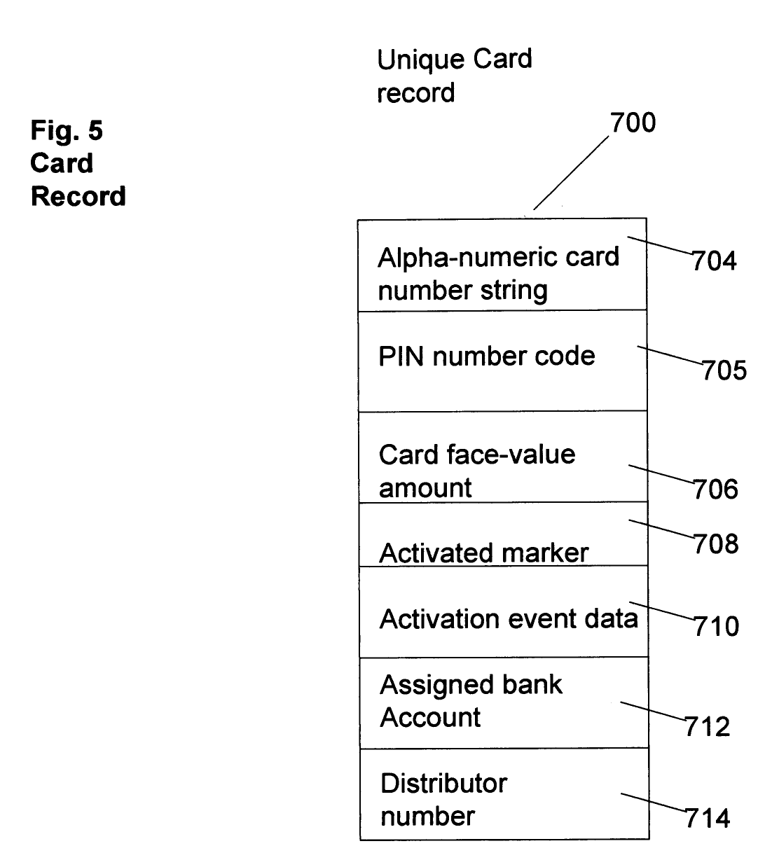

The Account Verification web site 110 advantageously includes a web server 134 and HTML forms 136, and a card database 139. Alternatively, the card database 139 can be held outside of, but accessible by, the Account Verification web site 110. FIG. 5 is a diagram of a card database record 700 housed on the card database 139 which each record holding information correlating to unique cards and card carriers 102.

The preferred embodiment of this invention is a system and method for use with the Internet 114, a widely known global computer network. This invention is, however, not limited to the Internet. Thus, as used herein, the term “network” refers to any distributed computer network whether it is a local area network (LAN), a wide area network (WAN), a telephone network or an Intranet.

The pre-defined vendor 112 can be any vendor who can make an approved transaction with an active bank account on the bank account database 132. In the preferred embodiment, the pre-defined vendor is the US Treasury which uses banks as agents to process US Savings Bond contract applications. The pre-defined vendor 112 can also be the US Treasury web site itself which is used to sell US Savings Bonds directly to consumers.

The recipient computer 118 may be any type of computing device that allows the recipient to interactively browse Web sites via a Web browser 140. For example, the seller computer 118 may be a personal computer (PC) that runs the Windows 2000 operating system running the Internet Explorer browser.

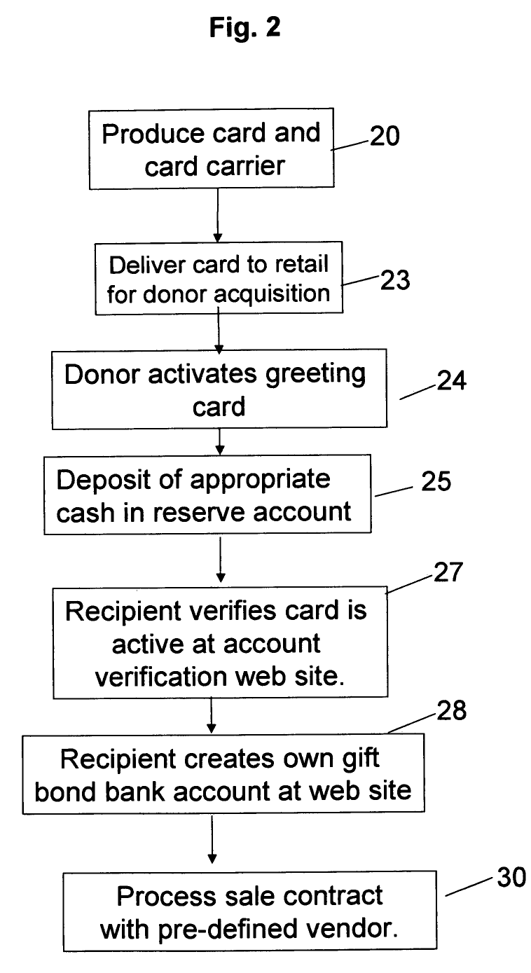

FIG. 2 is a general flow diagram of the method of this invention. Referring to this figure, the invention provides for the production of card and card carriers, step 20. During the card and card carrier production, card records (FIG. 5) are created and values are assigned to appropriate fields in each card record 700. Also during production, a unique card and card carrier 102 (FIG. 3) is printed with data from database fields for a unique card record 700 from the card database 139 along with the appropriate text instructions (FIG. 3d, 906 or FIG. 3b, 990).

Referring to FIG. 5, each card record 700 in the card database 139 includes an alpha-numeric card number string 704, a unique PIN number code 705, an assigned card face-value amount 706, an activation marker 708 originally set to N for not-activated but changed to Y when the card is activated at a retail location or activated by a donor, a blank field for recording activation event data 710 (such as date and time activated) and alternatively a field for the assigned bank account number for the card 712. Alternatively, each card record can also include a distributor number 714.

During production of the card and card carrier, each alpha-numeric card number string 704 and PIN number code 705 are assigned to a unique card and card carrier 102. Assignment can be via printing or encoding via a magnetic stripe or bar-code. Each correlated alpha-numeric card number string 704 and PIN number code 705 are assigned to one and only one card and card carrier 102 during production. In the preferred embodiment of the invention, a scratch-off film (997, FIG. 3a; 908 FIG. 3b; 904 FIG. 3d) is then layered over the printed PIN number code 705 hiding it from casual observation. In the preferred embodiment, the scratch-off film will be removed by the recipient at redemption and the PIN number code 705 will become visible to the recipient at that time. In one embodiment of the invention, an additional participating distributor number 714 is printed adjacent to the alpha-numeric card number card number string 704. Instructions for creating the recipient's gift bond account are also printed on the card and card carrier 102 (990, FIG. 3).

The card and card carrier 102 (FIG. 3b) is delivered to a retail location to await acquisition by a gift donor, step 23. Alternatively, at this step, a donor can be given a card free for later self-activation (FIG. 3c).

At step 24, the card and card carrier 102 is purchased by a donor at a retail location. The card and card carrier 102 relay the necessary information for use to both the gift donor prior to purchase and the gift recipient who both have access to read the card and card carrier 102. In the preferred embodiment, the card is activated at retail. In an alternative embodiment, as explained in the instructions (FIG. 3d, 910) the donor can take a card free and then simply activate their card before giving it to a recipient by using the donor's activation device 106, such as a touch-tone telephone 144 or a web browser 142, and activating the card with a payment. Purchase equals activation.

Next, in step 25 a deposit of appropriate cash is made to the reserve account. In this step, funds paid at activation by the donor and equal to the card face value amount field (706, FIG. 5) are made available in the reserved financial account 116 on the bank system 108 to fund the recipient's anticipated gift bond bank account. The reserved financial account 116 is periodically funded to cover gift bond bank accounts anticipated to be opened by activated card recipients so that at any given time there are enough funds in the reserved financial account 116 in the Participating Bank System 108 to fund the creation of a recipient's gift bond account at the bank, and thus available for the subsequent purchase of a US Savings Bond.

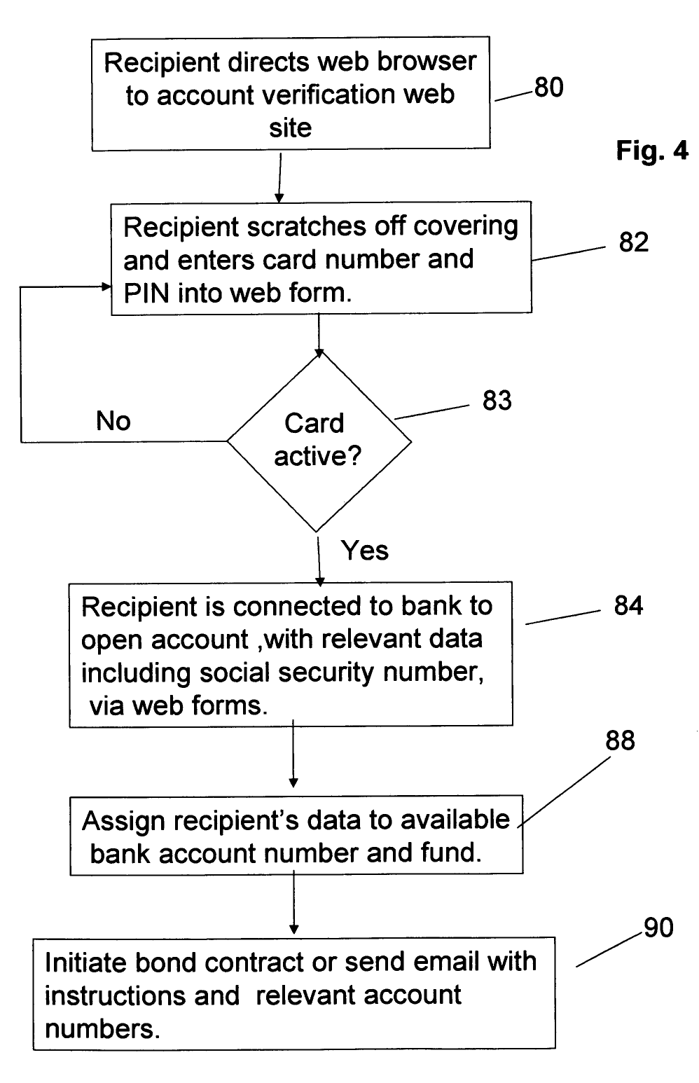

Returning to FIG. 2, the system includes an Account Verification website 110 which executes the verification of the recipient's active gift bond card, shown as step 27, recipient verifies card is active during the account verification step. Next, step 28 involves the recipient creating their own gift bond bank account at the Participating Bank System 108 web site. FIG. 4 is a detailed process flow diagram outlining steps 27 and 28, the verification of the active card and the creation of the bond account.

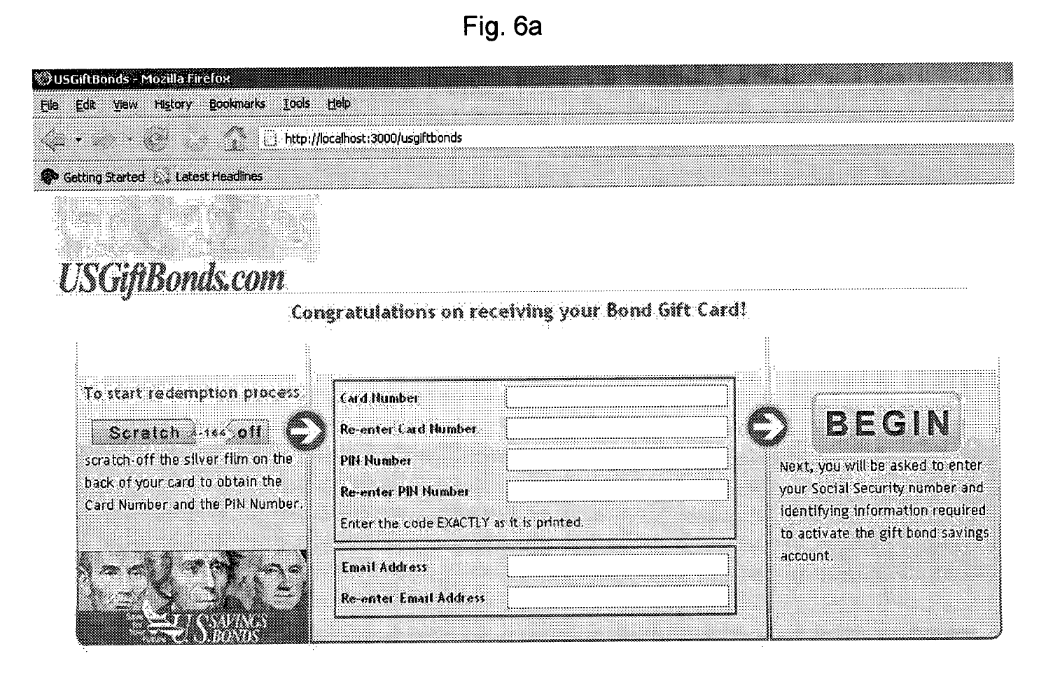

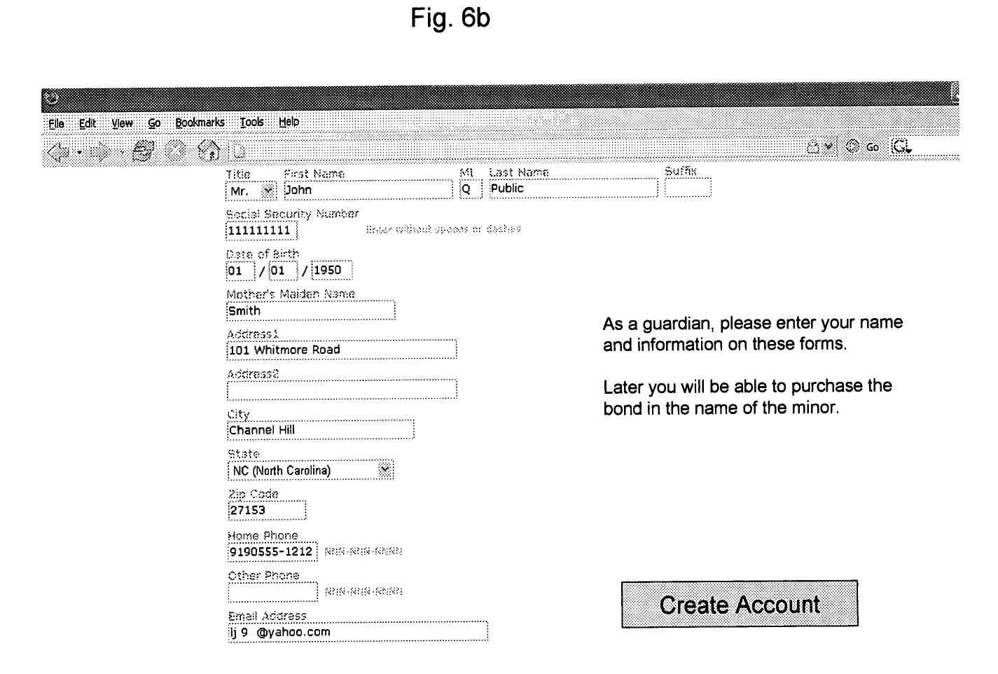

Referring to FIG. 4, step 80, the recipient uses the recipient's computer 118 and directs their web browser 140, to the Account Verification web site 110. At step 82, the recipient scratches off the PIN code 705 and enters both the PIN code 705 and card number 704 into HTML forms 136 (FIG. 6a). The recipient is optionally asked to enter their email address.

In Step 83, the system then validates the card number 704 is active by checking the activated marker field (708) for the card on the card db 138. Alternatively, the system can poll an external card database of activated card records by connecting to the card database 139 over the internet 114. If the card record shows not active, the system returns the buyer to step 83 to re-enter the card and PIN code. If the card record shows as active, the system moves to step 84, where it passes data for the active card number 704, the entered email address and the card face value amount 706 and the recipient's web browser 140 to the participating bank system's web server 130 to complete HTML forms 138 by the recipient entering name, address, email address, Social Security number and other relevant contact information (FIG. 6b) at the Participating Bank System 108.

At step 88, the Participating Bank System 108 assigns the recipient's data to an available bank account number and funds the newly created gift bond bank account. In this step, the participating bank account system 108 verifies the donor's entered information to satisfy know-your-customer bank account regulations as the bank system would do with any new bank account, and the bank assigns an available bank account number to the recipient and funds the newly created account by moving the appropriate funds held in the Reserved Account 116 identified to be used for the account as recorded in the card face-value amount 706 sent from the Account Verification web site 110. The card face value amount 706 is automatically moved by the participating bank system 108 from the reserved account 116 to the newly established recipient's bank account and recorded on the bank's bank account database 132.

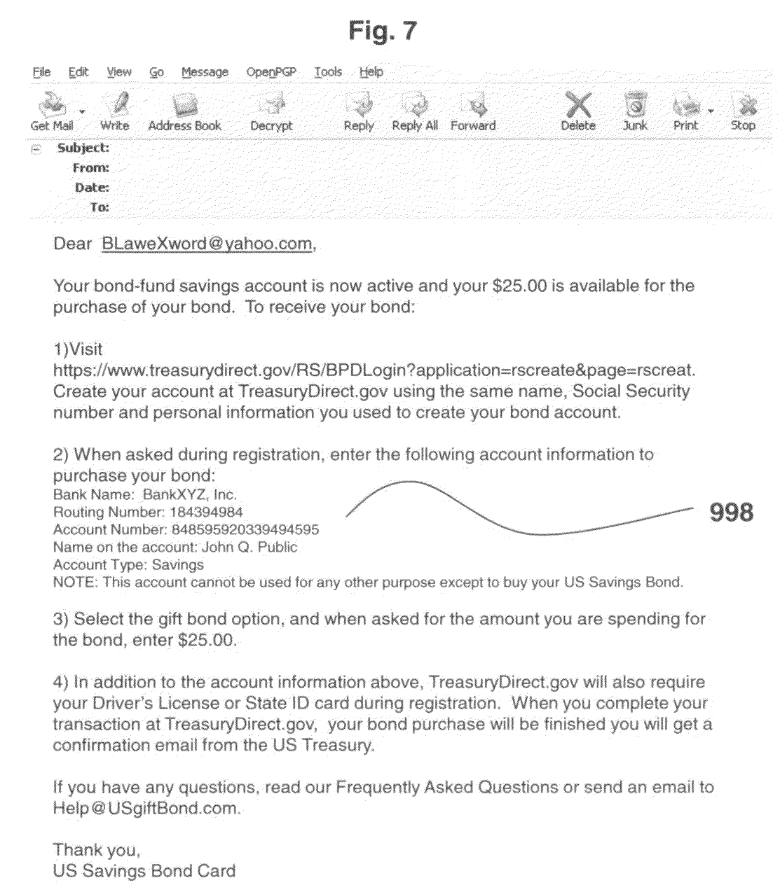

Next, the system moves to step 90 and the bank system 108 initiates the bond contract for the bond account holder as it would normally do as an agent of the US Treasury for any customer of the bank. In an alternative method for step 90, an email is created and sent to the recipient's entered email address explaining how the recipient can purchase a bond using the created bond bank account information. FIG. 7 is a sample email for the email alternative method. The email confirms the creation of the gift bond account at the bank and provides further instructions to the recipient to purchase the intended item. In the preferred embodiment, the intended item is a US Savings bond. In the alternative method of the program in step 90, the email contains the bank name, bank routing number, recipient's account number and amount of funds available (FIG. 7, 998) for use by the recipient when purchasing their item from the pre-defined vendor which is the US Treasury in the preferred embodiment.

It will be appreciated by those skilled in the art that numerous modifications and variations are possible, and that the invention may be practiced otherwise than as specifically described herein, without departing from the scope thereof.

I claim:

1. A method for creating a special purpose bond bank account used to automatically initiate a specific subsequent transaction, comprising: producing a uniquely numbered card; providing means for a donor to activate said uniquely numbered card with a payment; providing means for a card recipient to use the card to initiate a special purpose bond bank account at a bank; funding the special purpose bond bank account with the donor's activation payment; initiating automatically a specific subsequent transaction using information generated from the creation of the special purpose bond bank account; funding the specific subsequent transaction with the funds from the special purpose bond bank account.

2. The method of claim 1 wherein the specific subsequent transaction is for a US Savings Bond.

3. The method of claim 1 wherein the uniquely numbered card has an assigned unique card number and PIN code number.

4. The method of claim 3 wherein the uniquely numbered card includes instructions to create the special purpose bond bank account.

5. The method of claim 3 wherein the PIN code number is covered by a scratch-off film.

6. The method of claim 1 wherein the means for the donor to activate the card with payment is completed at retail checkout.

7. The method of claim 1 wherein the means for the donor to activate the card with payment is completed by a donor activation device.

8. The method of claim 7 wherein said donor activation device is a touch-tone telephone.

9. The method of claim 7 wherein said donor activation device is a web-browser.

10. The method of claim 1 wherein providing means to use the card to initiate the creation of a special purpose bond bank account is through relaying the card recipient's activated card number and the activation payment amount and the card recipient's personal information to the bank using internet forms.

11. The method of claim 1 wherein the funding of the special purpose bond bank account from the donor activation payment is done by the bank transferring funds from a general reserve account at the bank to the special purpose bond bank account created for the card recipient.

12. The method of claim 1 wherein the initiation of the specific subsequent transaction is executed automatically by the bank after the special purpose bond account is created.

13. The method of claim 12 wherein initiation of the specific subsequent transaction is for a US Savings Bond contract executed with information generated from the creation of the special purpose bond bank account including the name, social security number, and address of the card recipient.

14. The method of claim 1 wherein funding the specific subsequent transaction with the funds from the special purpose bond bank account is made by the bank providing funds for the specific subsequent transaction at the time of execution of the specific subsequent transaction.

15. A system for creating, funding and using a bank account for use in specific subsequent transaction from a pre-defined vendor, comprising:
a. a greeting card with a unique alphanumeric code; and,
b. an account creation web site capable of receiving an alphanumeric code as well as the recipient's social security number and identifying information; and
c. a participating bank system capable of receiving said recipient's social security number and identifying information to create and fund a bank account, said bank account only to be used to complete a specific subsequent transaction from said pre-defined vendor.

16. The system of claim 15 wherein said pre-defined vendor is the US Treasury Department.

17. The system of claim 15 wherein said specific subsequent transaction is for the purchase of a US Savings Bond.

18. An automated method, performed by a computer-based account creation system to provide for the creation and sale of a greeting card to be used in the creation, funding and use of a bank account, said bank account available to complete an automated clearing house transaction from a pre-defined vendor, the method comprising: producing said greeting card comprising a unique alpha-numeric character string and a cash value printed on the greeting card; printing the greeting card with instructions for creating said bank account; a donor purchasing said greeting card; said purchase triggering the funding of a reserve account; a recipient creating a bank account at an Account Creation web by inputting at least a social security number, recipient name and email address and one alpha-numeric character string from the greeting card; said account creation web site causing the assignment of a bank account for the recipient; said assignment triggering a transfer of cash equal to the amount printed on the greeting card from said reserved account to said assigned bank account; said bank account receiving and processing an automated clearing house request from said pre-defined vendor for funds.

19. The method of claim 18 wherein the pre-defined vendor web site is a web site operated by the US Treasury to sell US savings bonds.
